(19) United States
(12) Patent Application Publication
(10) Pub. No.: US 2008/0307834 A1
(43) Pub. Date: Dec. 18, 2008

(54) KEY AND COMBINATION CONTROLLED PADLOCK

(76) Inventor: Min-Tsung MA, Chang Hua County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/865,595

(22) Filed: Oct. 1, 2007

(30) Foreign Application Priority Data
Jun. 15, 2007 (CN) 200720152352.4

(51) Int. Cl. E05B 67/22

(52) U.S. Cl. 70/25; 70/38 R

(57) ABSTRACT

A padlock includes a housing with a notch, a shackle having a pivoting portion, which is disposed in the housing and axially moveable and pivotable, and a free end disposed in the housing and passable through the notch when the pivoting portion is pivoted. A combination controlled lock unit is adapted for controlling an axial movement of the pivoting portion for enabling the free end to move away from the housing to unlock the padlock. A key controlled lock unit includes a rotatable plug and a block member with a block portion rotatable along with the plug between a locking position where the block portion blocks the notch to stop the free end of the shackle from passing through the notch, and an unlocking position for allowing the free end of the shackle to pass through the notch when the pivoting portion is pivoted to unlock the padlock.

### BACKGROUND OF THE INVENTION

1. Field of the Invention

The present invention relates generally to locks and more specifically, to a padlock that includes a combination controlled lock unit and a key controlled lock unit, so that the padlock can be opened by using a key or a permutation of numbers or symbols.

2. Description of the Related Art

Conventional padlocks generally include two types, i.e. a key controlled type such as pin tumbler lock, which needs a correct key to unlock it, and a combination controlled type, which needs a correct permutation of numbers or symbols to unlock it.

However, if a user of a padlock of combination controlled type forgets the correct permutation of the numbers or symbols, the user will be unable to open the padlock and may have to break the padlock or ask a locksmith for help. If the user of a padlock of key controlled type loses the key, the user will encounter the same problem.

### SUMMARY OF THE INVENTION

The present invention has been accomplished in view of the above-noted circumstances. It is therefore one objective of the present invention to provide a padlock, which has a combination controlled lock unit and a key controlled lock unit such that a user can open the padlock by alternatively using a key or a permutation of numbers or symbols.

To achieve this objective of the present invention, the padlock comprises a housing with a notch, a shackle, a combination controlled lock unit and a key controlled lock unit. The shackle has a pivoting portion and a hook portion integrally connected with the pivoting portion and provided with a free end. The pivoting portion is disposed in the housing and axially moveable and pivotable relative to the housing. The free end of the hook portion is disposed in the housing and passable through the notch of the housing when the pivoting portion of the shackle is pivoted relative to the housing. The combination controlled lock unit is adapted for controlling an axial movement of the pivoting portion of the shackle relative to the housing for enabling the free end of the shackle to move away from the housing so as to unlock the padlock. The key controlled lock unit includes a plug rotatably disposed in the housing, and a block member connected with the plug and provided with a block portion rotatable along with the plug between a locking position where the block portion blocks the notch to stop the free end of the hook portion of the shackle from passing through the notch of the housing, and an unlocking position for allowing the free end of the hook portion of the shackle to move away from the housing through the notch to unlock the padlock when the pivoting portion of the shackle is pivoted relative to the housing.

As a result, the padlock can be opened by operating either the key controlled lock unit or the combination controlled lock unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of the padlock according to a first embodiment of the present invention;

FIG. 2 is a perspective view of the padlock according to the first embodiment of the present invention, showing the padlock locked;

FIG. 3 is another perspective view of the padlock according to the first embodiment of the present invention, showing that the free end of the shackle is outwardly moved away from the housing along with the axial movement of the pivoting portion of the shackle to unlock the padlock;

FIG. 4 is still another perspective view of the padlock according to the first embodiment of the present invention, showing that the free end of the shackle is moved away from the housing through the notch of the housing when the block portion of the block member is positioned at the unlocking position and the pivoting portion of the shackle is pivoted relative to the housing;

FIG. 5 is an exploded view of the padlock according to a second embodiment of the present invention;

FIG. 6 is a partial exploded view of the padlock of the second embodiment of the present invention, showing the free end of the shackle is stopped by the block portion of the block member such that the padlock is locked by the key controlled lock unit, and

FIG. 7 is similar to FIG. 6 but showing that the key controlled lock unit is unlocked.

### DETAILED DESCRIPTION OF THE INVENTION

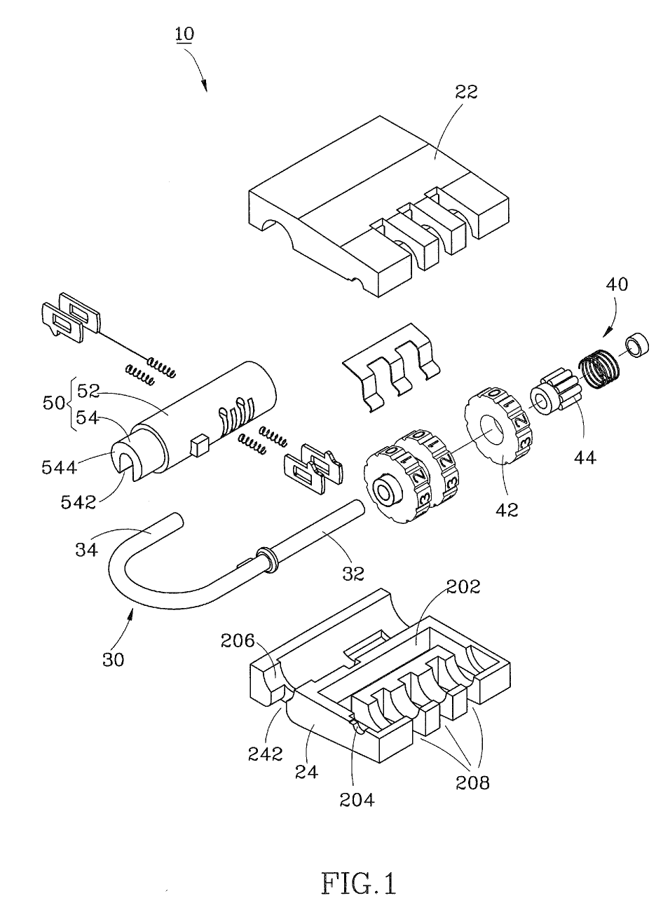

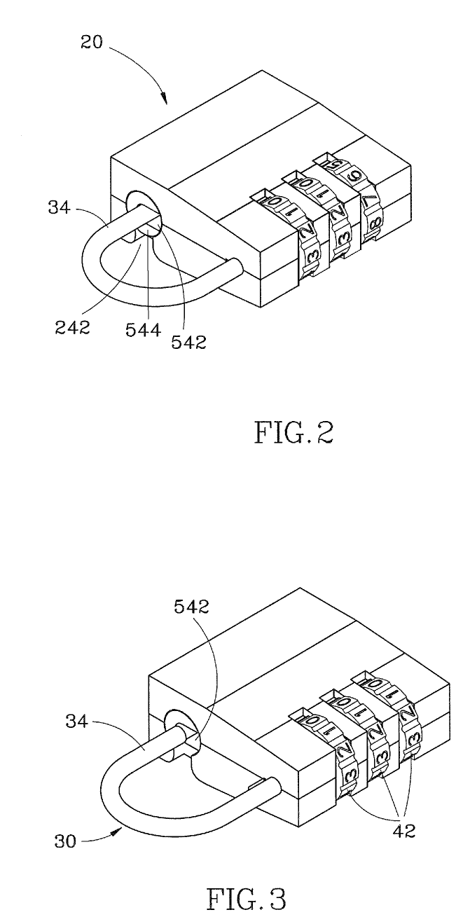

As shown in FIG. 1 and FIG. 2, a padlock 10 in accordance with a first embodiment of the present invention comprises a housing 20, a shackle 30, a combination controlled lock unit 40 and a key controlled lock unit 50.

The housing 20 includes a front shell 22 and a rear shell 24 with a notch 242. The front shell 22 and the rear shell 24 having a predetermined configuration respectively are coupled to each other so as to define an accommodation chamber 202 therebetween, a first top hole 204 in communication with the accommodation chamber 202, a second top hole 206 in communication with the accommodation chamber 202 and the notch 242 of the rear shell 24, and three openings 208 in communication with the accommodation chamber 202.

The shackle 30 has a pivoting portion 32 and a hook portion 34 integrally connected with the pivoting portion 32 and provided with a free end. The pivoting portion 32 of the shackle 30 is inserted into the accommodation chamber 202 of the housing 20 through the first top hole 204 of the housing 20 in such a way that the pivoting portion 32 is axially moveable relative to the housing 20 and pivotable about its longitudinal axis. The free end of the hook portion 34 is disposed in the second top hole 206 of the housing 20.

The combination controlled lock unit 40 is mounted in the accommodation chamber 202 of the housing 20, having three numbered wheels 42 sleeved onto the pivoting portion 32 of the shackle 30 and respectively and partially extending out of the openings 208 of the housing 20 for user's operation, and three retaining wheels 44 spacedly sleeved onto the pivoting portion 32 of the shackle 30 and respectively engaged with the numbered wheels 42 such that the pivoting portion 32 of the shackle 30 cam be controlled by the numbered wheels 42 to move in an axial direction of the numbered wheels 42. When the numbered wheels 42 are rotated to show a correct permutation, the pivoting portion 32 of the shackle 30 can be moved upwards such that the free end of the hook portion 34 of the shackle 30 can be moved away from the housing 20 along with the axial movement of the pivoting portion 32 of the shackle 30. On the contrary, when the numbered wheel 42 show a wrong permutation, the pivoting portion 32 of the shackle 30 cannot be moved axially due to the restriction of the retaining wheels 44.

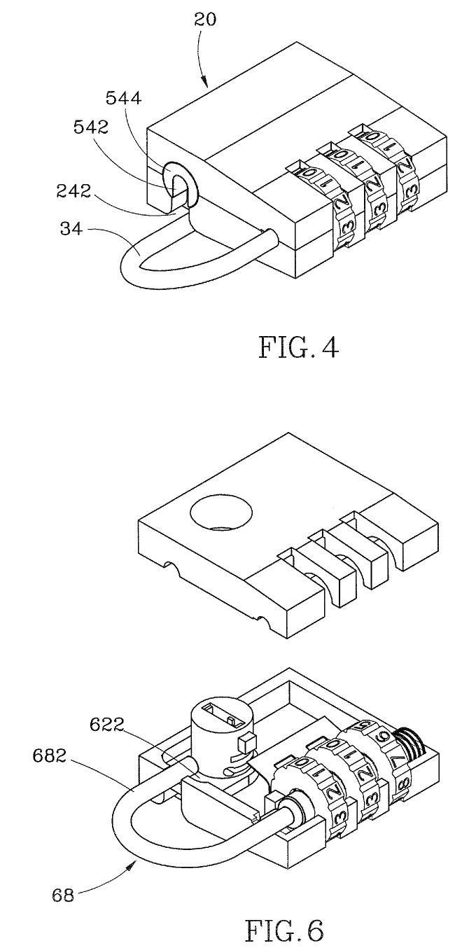

The key controlled lock unit 50 is mounted in the accommodation chamber 202 of the housing 20, having a plug 52 with a keyway having a keyhole (not shown) at a bottom end thereof for insertion of a key, and a cylindrical block member 54 integrally mounted on a top end of the plug 52, received in the second top hole 206 of the housing 20 and provided with an insertion groove 542 for insertion of the free end of the hook portion 34 of the shackle 30 and a block portion 544 formed by a periphery of the insertion groove 542. The plug 52 and the block member 54 are simultaneously rotatable by the key between a locking position and an unlocking position. When the plug 52 is located at the locking position, the block portion 544 of the block member 54 is rotated to block the notch 242 of the housing 20, i.e. the insertion groove 542 of the block member 54 and the notch 242 of the housing 20 are staggered, such that the free end of the hook portion 34 of the shackle 30 cannot be allowed to pass from the insertion groove 542 of the block member 54 to the notch 242 of the housing 20, resulting in that the shackle 30 cannot be pivoted relative to the housing 20, as shown in FIG. 2. When the plug 52 is located at the unlocking position, the block portion 544 of the block member 54 is moved away from the notch 242 of the housing 20, i.e. the insertion groove 542 of the block member 54 is in communication with the notch 242 of the housing 20, such that the free end of the hook portion 34 of the shackle 30 can be allowed to pass through the notch 242 of the housing 20, resulting in that the shackle 30 can be pivoted relative to the housing 20, as shown in FIG. 4.

When the padlock 10 is locked, as shown in FIG. 2, the pivoting portion 32 of the shackle 30 cannot be axially moved due to the restriction of the retaining wheels 44 of the combination controlled lock unit 40, and the free end of the hook portion 34 of the shackle 30 is stopped by the block portion 544 of the block member 54 from passing the insertion groove 542 of the block member 50. When a user rotates the numbered wheels 42 to show a correct number permutation, the pivoting portion 32 of the shackle 30 can be forced to axially move upwards such that the free end of the hook portion 34 of the shackle 30 is moved away from the insertion groove 542 of the block member 54, as shown in FIG. 3. Therefore, the shackle 30 is pivotable, and the padlock 10 is unlocked. As long as the user presses the shackle 30 directly and downwards for enabling the hook portion 32 of the shackle 30 to be inserted into the insertion groove 542 of the block member 54, the padlock 10 is locked.

When the key is inserted into the keyhole of the plug 52 and rotated 90 degrees, the insertion groove 542 of the block member 54 is in communication with the notch 242 of the housing 20, as shown in FIG. 4, and therefore the free end of the hook portion 34 of the shackle 30 can be allowed to pass from the insertion groove 542 of the block member 54 to the notch 242 of the housing 20, resulting in that the shackle 30 can be pivoted relative to the housing 20 to unlock the padlock 10.

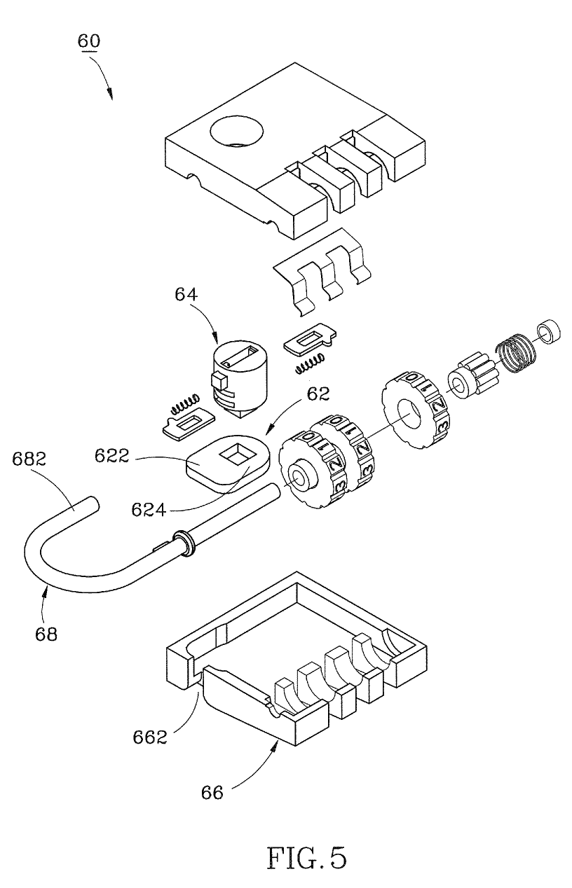

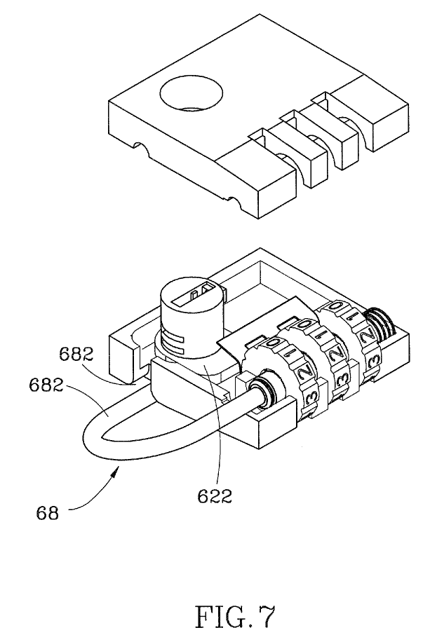

FIG. 5 shows a padlock 60 in accordance with a second embodiment of the present invention. This embodiment is substantially similar to the aforesaid first embodiment with the exception of the block member. According to this second embodiment, the block member, referenced by 62, is substantially a rectangular plate and eccentrically mounted on a bottom end of the plug 64 so as to form a cam having a long-sided protrusion 622 and a short-sided protrusion 624 at the bottom of the plug 64. The long-sided protrusion 622 of the block member 62, which acts as the block portion of the block member, projects into the notch 662 of the housing 66 when the plug 64 is rotated to the locking position. Thus, when the key is not inserted into the keyhole of the plug 64, the long-sided protrusion 622 of the block member 62 will project into the notch 662 of the housing 66, as shown in FIG. 6, and the free end of the hook portion 682 of the shackle 68 is stopped by the long-sided protrusion 622 of the block member 62, and therefore the shackle 68 is not rotatable. On the contrary, when the key is inserted into the keyhole of the plug 64 and rotated, the long-sided protrusion 622 of the block member 62 is moved away from the notch 662 of the housing 66, as shown in FIG. 7, and the free end of the hook portion 682 of the housing 68 can pass through the notch 662 of the housing 66 such that the shackle 68 is rotatable, causing the padlock 60 to be unlocked.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A padlock comprising:
a housing having an accommodation chamber, first and second top holes in communication with the accommodation chamber, and a notch in communication with the second top hole;
a shackle having a pivoting portion, which passes through the first top hole into the accommodation chamber and is axially moveable and pivotable relative to the housing, and a hook portion integrally connected with the pivoting portion and provided with a free end located in the second top hole and passable through the notch of the housing when the pivoting portion is pivoted relative to the housing;
a combination controlled lock unit having a plurality of wheels rotatably sleeved onto the pivoting portion of the shackle for controlling an axial movement of the pivoting portion of the shackle relative to the housing for enabling the free end of the shackle to move away from the housing to unlock the padlock; and
a key controlled lock unit having a plug rotatably disposed in the accommodation chamber of the housing, and a block member connected with the plug and provided with a block portion rotatable along with the plug between a locking position where the block portion blocks the notch to stop the free end of the hook portion of the shackle from passing through the notch, and an unlocking position for allowing the free end of the hook portion of the shackle to pass through the notch when the pivoting portion is pivoted relative to the housing to unlock the padlock.

2. The padlock as claimed in claim 1, wherein the block member of the key controlled lock unit is integrally connected to a top end of the plug and provided with an insertion groove for insertion of the free end of the hook portion of the shackle; the block portion of the block member is formed on an periphery of the insertion groove of the block member; the insertion groove of the block member is in communication with the notch of the housing when the plug of the key controlled lock unit is located at the unlocking position, and the insertion groove of the block member and the notch of the housing are staggered when the plug of the key controlled lock unit is located at the locking position.

3. The padlock as claimed in claim 1, wherein the block member of the key controlled lock unit is a plate eccentrically connected with the plug and defining the block portion which projects into the notch of the housing when the plug is rotated to the unlocking position.
